(19) United States
(12) Patent Application Publication
(10) Pub. No.: US 2019/0029178 A1
(43) Pub. Date: Jan. 31, 2019

(54) A ROBOTIC HARVESTER

(71) Applicant: QUEENSLAND UNIVERSITY OF TECHNOLOGY, Brisbane, Queensland (AU)

(72) Inventors: Ray RUSSEL, Beaver, PA (US); Christopher LEHNERT, Brisbane, Queensland (AU)

(21) Appl. No.: 16/082,551

(22) PCT Filed: Mar. 7, 2017
(86) PCT No.: PCT/AU2017/050199

§ 371 Date: Sep. 6, 2018

(30) Foreign Application Priority Data
Mar. 7, 2016 (AU) 2016900842

(51) Int. Cl. A01D 46/30

(52) U.S. Cl. CPC A01D 46/30

(57) ABSTRACT

A crop picking end effector for robotic harvesting of crops includes a body. A cutting mechanism is arranged on the body and is operable to cut a stem or stalk of the crop. A gripper is operable to attach itself to the crop. A decoupling mechanism includes a tether connected to the gripper and tethering the gripper with respect to the body. A releasable securing mechanism releasably secures the gripper with respect to the cutting mechanism and is configured to allow the gripper to decouple, thereby to release the gripper with respect to the cutting mechanism.

### FIELD

Various exemplary embodiments of a robotic harvester, a crop picking end effector of the robotic harvester, and a method of harvesting crop are described in this specification.

### BACKGROUND

Harvesting of high value crops, such as capsicums, is a labour-intensive task that occurs multiple times during the growing season. Automation of the harvesting task may result in a significant labour saving and may provide gentler handling of the fruit.

An important part of any robotic fruit picking system is the end effector. The end effector is used by the robot to touch and interact with the crop and its design is critical to reliable handling and detachment of the crop.

### SUMMARY

Performing a gripping and cutting motion simultaneously with a single end effector is challenging due to the natural variation in fruit size and shape making it difficult to choose a path for the end effector that simultaneously allows reliable gripping and cutting. To overcome this difficulty, the end effector of the present application has a passive decoupling mechanism which allows gripping and cutting poses of the end effector to occur in series, and independently of each other, for each piece of fruit.

Various embodiments of a crop picking end effector for robotic harvesting of crops include:

a body;

a cutting mechanism arranged on the body and operable to cut a stem or stalk of the crop;

a gripper operable to attach itself to the crop; and

a decoupling mechanism including
a tether connected to the gripper and tethering the gripper with respect to the body, and
a releasable securing mechanism which releasably secures the gripper with respect to the cutting mechanism, the releasable securing mechanism configured to allow the gripper to decouple, thereby to release the gripper with respect to the cutting mechanism.

The releasable securing mechanism may be a magnet interposed between the cutting mechanism and the gripper. The tether may be resiliently deformable to spring back into an initial shape and the releasable securing mechanism may include the resilient deformability of the tether. The gripper may be a suction cup.

The tether may be a flexible strip. One end of the tether may be attached to the body and another end may be attached to the gripper.

The end effector may include a vision system used to detect the crop.

The cutting mechanism may be an oscillating power tool including a cutting blade. The magnet may stick or adhere to an underside of the cutting blade to secure the gripper with respect to the cutting blade. The cutting mechanism may include a guard positioned along the cutting blade.

Various embodiments of a robotic harvester include a robotic arm and the end effector as described above mounted to a tool end of the robotic arm.

The vision system may be mounted to the robotic arm or be part of the end effector.

The robotic harvester may include a vacuum pump which is in fluid communication with the gripper via a vacuum hose.

Various embodiments of a method of harvesting crops with a robotic harvester include:

attaching a gripper to the crop using a robotic arm;

decoupling the gripper from the robotic arm so that the robotic arm is operable to move while the gripper remains attached to the crop;

moving the robotic arm to a position where a cutting mechanism of the robotic harvester can target a stem or stalk of the crop; and

cutting the stem or stalk with the cutting mechanism while the gripper is decoupled and attached to the crop.

The method may include moving the robotic arm so that the gripper recouples with the robotic arm. The method may include releasing the crop from the gripper.

The method may include moving the gripper to a drop-off position after the gripper has recoupled with the robotic arm and before releasing the crop from the gripper. The method may include releasing the crop from the gripper before the gripper has recoupled with the robotic arm.

The gripper may be attached to the crop using suction.

The gripper may be decoupled from the robotic arm by breaking a magnetic connection when moving the robotic arm while the gripper remains attached to the crop.

### BRIEF DESCRIPTION OF THE DRAWINGS

FIG. 1 shows a perspective exploded view of an embodiment of an end effector for robotic harvesting of crop.

FIG. 2 shows a perspective assembled view of the end effector of FIG. 1 with a gripper of the end effector in a coupled condition.

FIG. 3 shows a perspective assembled view of the end effector of FIG. 1 with the gripper in a decoupled condition.

FIG. 4 shows a perspective view of a robotic harvester including the end effector of FIG. 1 mounted to a tool end of a robotic arm of the harvester.

FIG. 5 shows another perspective view of the robotic harvester of FIG. 4.

FIG. 6 shows a perspective view of the end effector of FIG. 1 with a vision system of the end effector scanning a capsicum prior to coupling a gripper with the capsicum.

FIG. 6 shows a perspective view of the end effector of FIG. 1 with its gripper latched to a capsicum while coupled to a cutting blade of the end effector.

FIG. 7(a) shows a perspective view of the end effector of FIG. 1 with the gripper coupled to the cutting blade and the capsicum.

FIG. 7(b) shows a perspective view of the end effector of FIG. 1 with the gripper decoupled from the cutting blade so that the cutting blade can cut the stalk of the capsicum.

FIG. 7(c) shows a perspective view of the end effector of FIG. 1 with the gripper directed downwardly prior to release of the capsicum.

FIG. 7(d) shows a perspective view of the end effector of FIG. 1 with the recoupled with the cutting blade and the capsicum released from the gripper to fall into a basket.

FIG. 8 shows a flow chart of different stages of robotic harvesting using the robotic harvester of FIG. 4.

FIG. 9 shows a logic flow chart with different decision points for robotic harvesting using the robotic harvester of FIG. 4.

FIG. 10 shows a block diagram of a software system of the robotic harvester of FIG. 4.

FIG. 11 shows different states of a state machine of the software system of FIG. 12.

FIG. 12 shows different superellipsoids used by the software system of FIG. 10 to fit to a capsicum.

FIG. 13 shows a superellipsoid fitted to a capsicum.

FIG. 14 shows a perspective view of another embodiment of a gripper for the end effector of FIG. 1.

FIG. 15 shows a perspective view of still another embodiment of a gripper for the end effector of FIG. 1.

FIG. 16(a) shows a perspective view of another embodiment of a cutting mechanism for the end effector of FIG. 1, in a first stage of operation.

FIG. 16(b) shows a perspective view of the cutting mechanism of FIG. 16(a), in a second stage of operation.

FIG. 16(c) shows a perspective view of the cutting mechanism of FIG. 16(a), in a third stage of operation.

FIG. 17(a) shows a sectional side view of another embodiment of a releasable securing mechanism coupling the gripper to the cutting blade, in a secured condition.

FIG. 17(b) shows the releasable securing mechanism of FIG. 17(a) in a released condition.

FIG. 18 shows a three-dimensional view of an embodiment of a robotic harvester.

FIG. 19 shows another view of the robotic harvester of FIG. 21.

FIG. 20 shows the robotic harvester of FIG. 18, in use.

FIG. 21 shows a capsicum detection pipeline.

FIGS. 22(a) and (b) show precision-recall curves of red and green capsicum detection processes.

### DETAILED DESCRIPTION

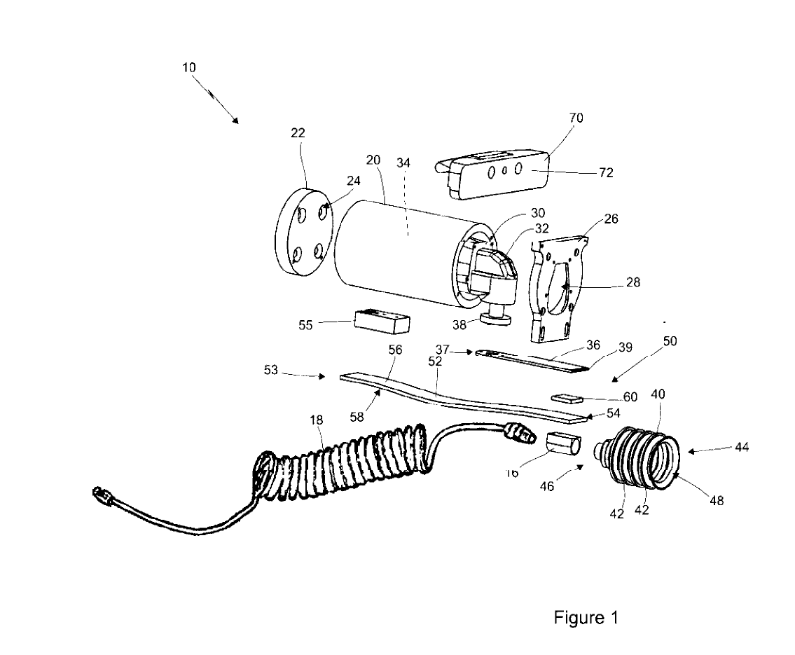

In FIGS. 1 to 3, reference numeral 10 generally indicates an embodiment of a robotic end effector for a robotic harvester. The end effector 10 is designed for autonomous picking of capsicums, but may be used with other types of crops. Capsicums are also known as bell peppers, sweet peppers, or just peppers.

The term “crop” as used in this specification includes reference to a single fruit or vegetable, for example a capsicum, cucumber, apple, orange, pepper or nectarine.

The end effector 10 includes an end effector body, framework or support structure 20, a cutting mechanism in the form of an oscillating cutting tool 30, a gripper in the form of a suction cup 40, and a decoupling mechanism 50. The mechanism 50 includes a tether that tethers the gripper with respect to the body 20. The tether is in the form of a flexible strip 52. The effector 10 includes a releasable securing mechanism in the form of a magnet 60, and a vision system 70. The cutting tool 30 can also be a rotary or some other form of cutting or separating tool.

The end effector body 20 is generally cylindrical in this example. The end effector body 20 is mounted to a tool point of a robotic arm using a rear plate 22. The rear plate 22 closes off a rear end of the end effector body 20. The rear plate 22 has a mounting arrangement for mounting the end effector 10 to the tool point of the robotic arm. Any suitable mounting arrangement may be used. In this example, the mounting arrangement includes spaced holes 24 for suitable fasteners.

The front of the end effector body 20 is closed off by a front plate 26. The front plate 26 has a window 28 through which a head 32 of the cutting tool 30 protrudes. The front plate 26 has a mounting arrangement for mounting the front plate 26 to the body 20. The mounting arrangement is in the form of various holes, in this example, for suitable fasteners. Any other suitable mounting arrangement may be used for the front plate. The front plate 26 includes a mounting arrangement for fixing the front plate 26 to the front of the effector body 20, a mounting arrangement for fixing the cutting tool 30 to the front plate 26, and a mounting arrangement for mounting the vision system 70 to the front plate 26. These mounting arrangements may include holes for example, for suitable fasteners.

The cutting tool 30 includes a body 34 housing an electric motor (not shown), the head 32 and a cutting blade 36. The cutting tool body 34 is received in the end effector body 20. The head 32 includes a tool holder 38 to which one end 37 of the cutting blade 36 is releasably fixed. A distal end 39 of the blade 36 is serrated to form a cutting edge of the blade 36.

The electric motor is coupled to the tool holder 38 to oscillate the tool holder 38, as is known in the art of oscillating power tools. The tool holder 38 may oscillate at between 50 and 500 Hz. The cutting blade 36 oscillates with the oscillations of the tool holder 38. During the oscillating action, the cutting blade 36 moves along a minimal arc of between 1 and 5 angular degrees. One example of a suitable oscillating power tool is the Ozito brand Multi-Function Tool, Model MFR-2100, available from Bunnings Warehouse in Australia. The MFR-2100 Multi-Function Tool operates at a variable speed of between 15,000 and 22,000 oscillations per minute (OPM) with an oscillation arc or orbital angle of about 2.8 degrees. Power for the electric motor is supplied from a suitable power source (not shown), such as a rechargeable battery or a power cord connected to grid power.

If the releasable securing mechanism is in form of a magnet, then the cutting blade 36 is of a ferrous material or ferromagnetic material, such as steel, to which the magnet 60 can attach by magnetic attraction. Otherwise the cutting blade may be of any other suitable material.

The suction cup 40 in this example is a vacuum gripper. For example, the suction cup 40 is a concertina bellow type suction cup with annular folds 42 spaced between a front end 44 and a rear end 46 of the suction cup 40. The suction cup 40 is of a suitably deformable material, such as silicone, nitrile-PVC or rubber. The suction cup 40 is resiliently deformable in concertina fashion in a manner wherein it returns to its original shape after being compressed. One example of a suitable vacuum gripper is the BL50-2 model suction cup available from Piab AB, Sjöflygvägen 35, TÄBY, Sweden.

The suction cup 40 has a mouth 48 defined at the front end 44, which attaches to a surface of a crop, under suction, as described in more detail below. The rear end 44 attaches to a hose coupling 16. The hose coupling 16 connects the suction cup 40 to a vacuum hose 18. The vacuum hose 18 is, in turn, connected to a vacuum pump (not shown). In some embodiments, the vacuum hose 18 and the flexible strip 52 are integrally formed.

The tongue or strip 52 tethers the suction cup 40 to the end effector body 20. The strip 52 has a proximal end 53 and a distal end 54. The proximal end 53 is fixed to the end effector body 20 via a bracket 55. The hose coupling 16 is fixed to the underside of the strip 52 at the distal end 54. The suction cup 40 is carried at the distal end 54 of the strip 52 by being attached to the hose coupling 16.

The strip 52 can be of fixed length. The strip 52 is generally rectangular and has a thickness. The strip 52 has a planar face 56 defining the top of the strip 52 and a planar face 58 defining the underside of the strip 52. The two faces 56, 58 are parallel to each other. The strip 52 has flexibility in a plane perpendicular to the faces 56, 58, but is relatively rigid in the transverse direction parallel to the faces 56, 58. It follows that the strip is constrained to flex or bend substantially in a consistent, single plane. The strip 52 may be of any suitable flexible material, including plastics, metal or composite materials. The strip 52 can be magnetic to aid in attachment and alignment of the magnet 60 to the underside of the blade 36.

In one embodiment, the strip 52 is resiliently deformable in the plane perpendicular to the faces 56, 58. Thus, the strip 52 is biased to return to an initial shape or position, which is preferably substantially straight. One example of a resiliently deformable strip would be if the strip 52 had a curved transverse profile, so that the strip is biased to spring back to a straight shape, as is known for concave blades of tape measures. The strip 52 can also be hinged and can include a biasing mechanism such as a spring to return it to an initial shape or position after a crop is released from the gripper.

The magnet 60 is fixed on top of the strip 52, to the face 56, at the distal end 54. The magnet 60 and the hose coupling 16 are opposite each other on different sides of the strip 52. In another embodiment, the magnet 60 is fixed to the underside of the cutting blade 36 and the strip 52 is ferrous so that the magnet 60 attaches to the strip 52. In yet another embodiment, one magnet may be fixed to the underside of the cutting blade 36 and another magnet may be fixed to the strip 52.

The magnet 60 is magnetically attached to the underside of the cutting blade 36. The magnet 60 is selected to have a strength sufficient to support the suction cup 40 when attached to the underside of the blade 36. The underside of the blade 36 may have a guide formation or socket for locating the magnet in a set position on the underside of the blade 36. Sufficient separation force between the suction cup 40 and the cutting blade 36 detaches the magnet 60 from the underside of the blade 36.

It is convenient for the strip 52 to attach to the underside of the cutting blade 36, but the end effector 10 may also have a dedicated gripper support to which the strip or gripper attaches.

Instead of the tongue or strip, the cup 40 can be tethered to the body 20 with other mechanisms, such as a retractable reel.

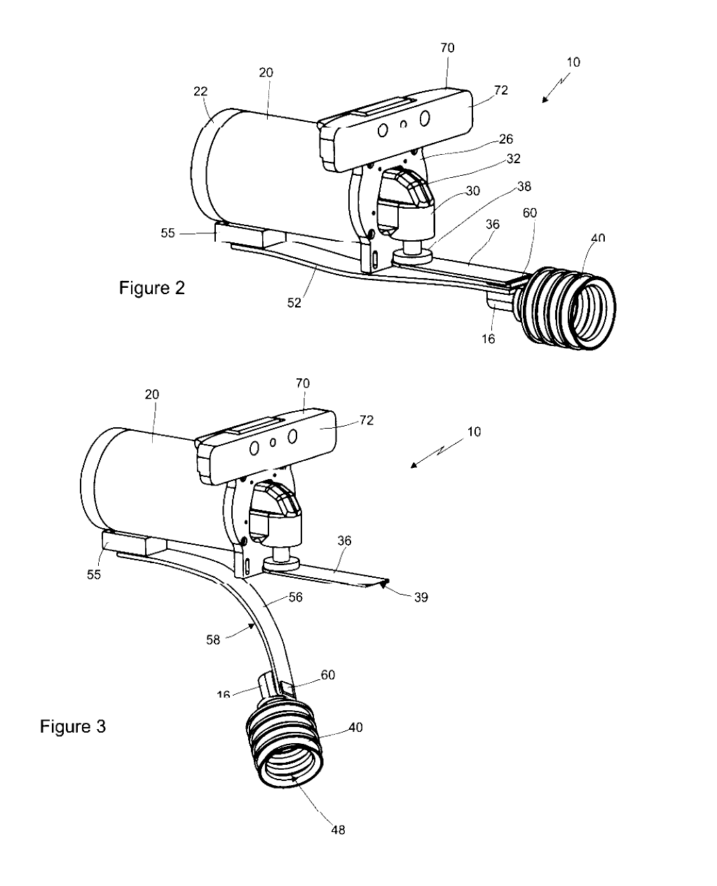

FIG. 2 shows the end effector 10 in a coupled condition of the decoupling mechanism 50, wherein the magnet 60 is attached to the underside of the blade 36. FIG. 3 shows the end effector 10 in a decoupled condition of the decoupling mechanism 50, wherein the magnet 60 is released from the underside of the blade 36 so that the suction cup 40 is tethered to the effector body 20 by the strip 52. The suction cup 40 and strip 52 dangle from the effector body 20.

The magnet 60 is a permanent magnet. In another embodiment, the magnet 60 may be an electromagnet. The electromagnet may be selectively de-energized to release the suction cup 40 from the blade 36.

Other types of releasably securable mechanisms may be used to releasably secure the suction cup to the blade 36. Other types of releasably securable mechanisms include hook-and-loop fasteners, clips, vacuum activated releases, electrically activated latches, etc.

The vision system 70 is a RGB-D camera 72 that provides images and depth information. The RGB-D camera 72 is a commercially available Intel® Realsense F200 RGB-D camera which includes a colour camera and a depth camera with IR light source. Other types of visions systems such as a ranging camera, flash lidar, stereo cameras, or time-of-flight (ToF) camera that use sensing mechanisms such as range-gated ToF, RF-modulated ToF, pulsed-light ToF, and projected-light stereo, may also be suitable. The vision system 70 provides images and depth information for each pixel in the images.

The end effector 10 is designed to remove a capsicum by gripping the capsicum in a first pose, and then moving to a second pose to target a stem of the capsicum with the cutting blade 36. The stem is also referred to as the stalk or peduncle. Decoupling the suction cup 40 from the blade 36 allows the end effector 10 to move to the second pose without unlatching the suction cup 40 from the capsicum. The suction cup 40 being tethered by the strip 52 allows the capsicum to remain attached to the end effector 10 after the stem is cut.

The method of picking a capsicum, or other type of crop, using the end effector 10 is described in detail below.

### Robotic Harvester

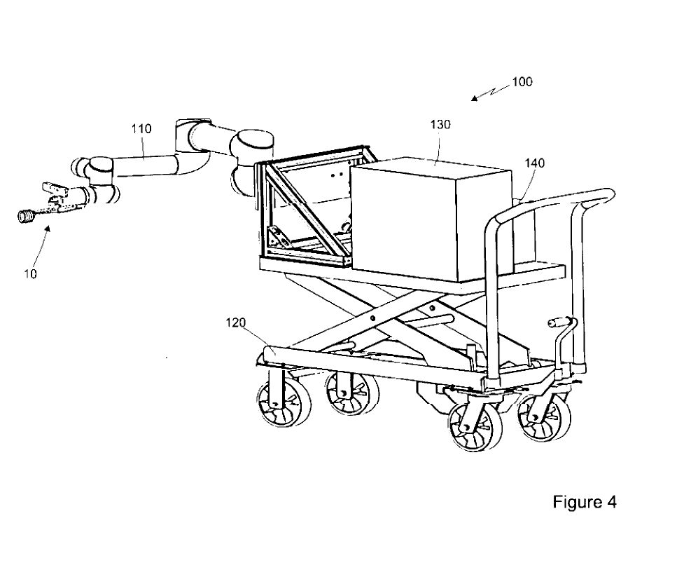

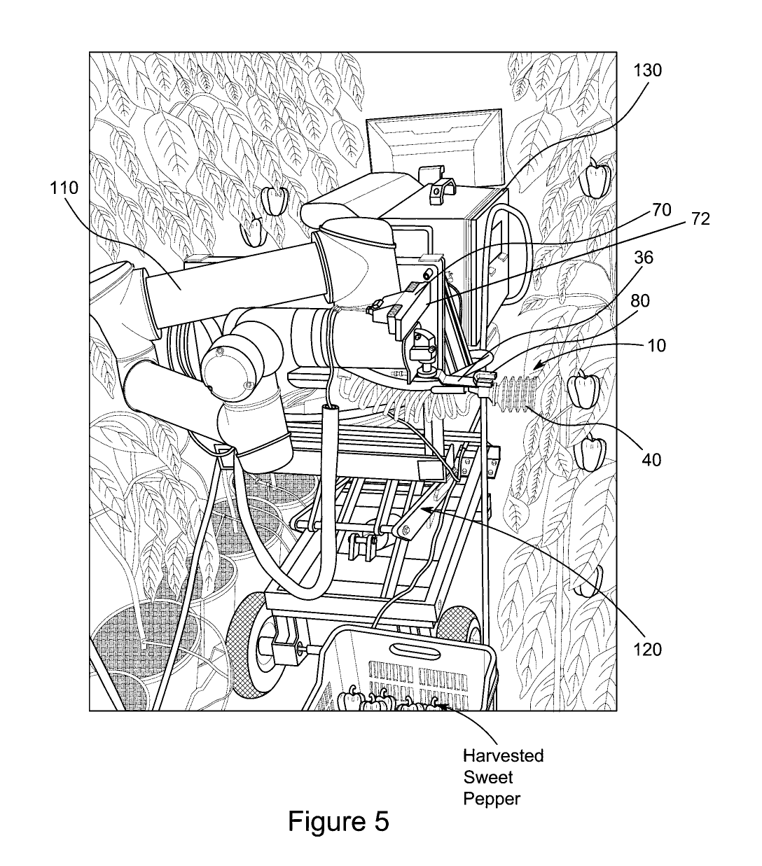

FIGS. 4 and 5 show a harvesting robot or robotic harvester 100 including the end effector 10. The harvester 100 further includes a robotic manipulator or robotic arm 110, a mobile variable height platform or base 120, an electronic control box 130 and a vacuum pump 140.

The electronic control box 130 includes a computer and the appropriate control hardware for operating the robotic arm 110 and the end effector 10.

The variable height base 120 is a manual scissor lift 122 which enables the base of the robotic arm 110 to be positioned horizontally and vertically within each row of a protected cropping system. The base 120 can be interchanged with an electric drive platform enabling further autonomy of the harvesting process.

The robotic arm 110 is a commercially available UR5 robot arm available from Universal Robots A/S Denmark. The end effector 10 is mounted on the tool point of the UR5 robot arm. The UR5 robot arm is a six Degree-of-Freedom (DoF) manipulator. However other robot arms may be used.

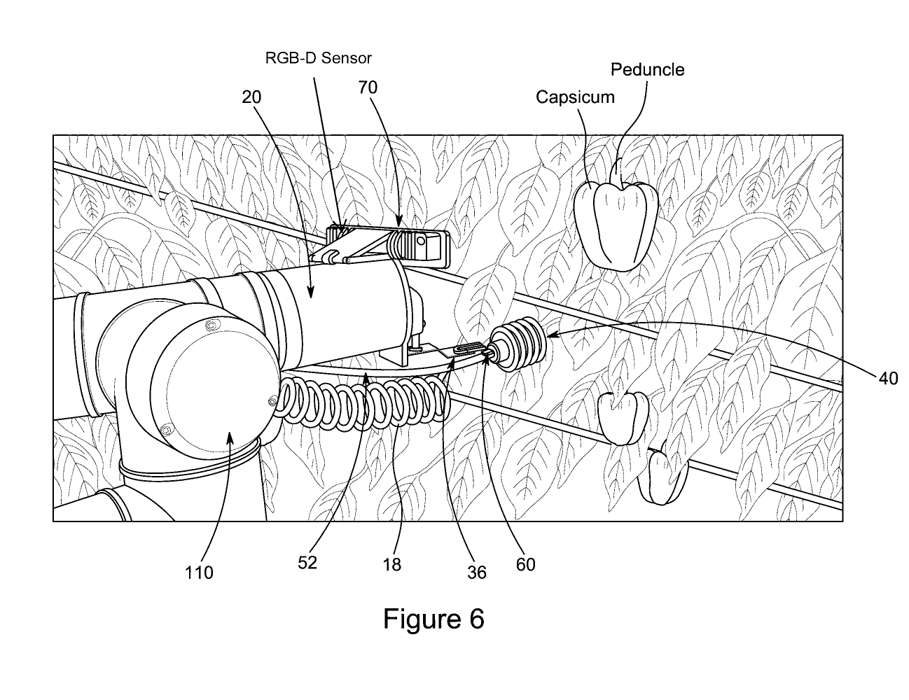

The vision system 70 is mounted near the front of the end effector body 20 to allow the vision system 70 to identify the shape and location of each capsicum in an eye-in-hand configuration, as can be seen in FIG. 6.

The cutting blade 36 of the harvester 100 shown in FIG. 5 includes a guard 80 towards the cutting edge of the blade 36. The guard 80 is configured and oriented to shield lateral sides of the blade cutting edge for safety and so as not to cut into the plant other than into the stem of a fruit immediately in front of the cutting blade 36. The guard 80 may be fixed to the cutting blade 36 to move with the oscillations of the cutting blade 36, or may be fixed to the body 20 to remain stationary as the cutting blade oscillates. The guard 80 can have a U-shaped profile to correspond with the stem or stalk.

Performing a gripping and cutting motion simultaneously with a single end effector is challenging due to the natural variation in fruit size and shape making it difficult to choose a path for the end effector that simultaneously allows reliable gripping and cutting. To overcome this difficulty, the end effector 10 has a passive decoupling mechanism design that allows independent gripping and cutting operations to occur in series on each piece of fruit. This decoupling mechanism is the strip 52 that attaches the suction cup 44 to the body 20. The suction cup 44 can also be attached to the underside of the cutting blade 36 with a magnet. During the gripping operation, the suction cup is magnetically attached to the cutting blade 36, allowing the robot arm to control the position of the suction cup 44 to grip the capsicum or crop. During the cutting operation, the suction cup passively detaches from the cutting blade, while remaining attached to the body of the end effector by the flexible strip, allowing it to move independently of the cutting blade. This simple and passive decoupling method requires no additional active elements such as electronics, actuators or sensors, and allows independent gripping and cutting locations to be chosen for each piece of fruit, which in turn allows significantly more reliable harvesting.

### Autonomous Harvesting

The robotic harvester 100 performs a number of steps to harvest a crop. The steps of autonomous harvesting of a crop, such as capsicum, are described below.

Scan crop: The arm 110 is moved around the location of the crop to build a 3D scene using the vision system 70.

Segment crop: Using colour information generated by the system 70, the crop is segmented from the 3D scene using the computer.

Estimate Pose: The pose of the crop is computed by the computer using an online non-linear optimisation which fits a parametric model to the segmented 3D model. An implemented non-linear optimisation or any other suitable optimisation may be used.

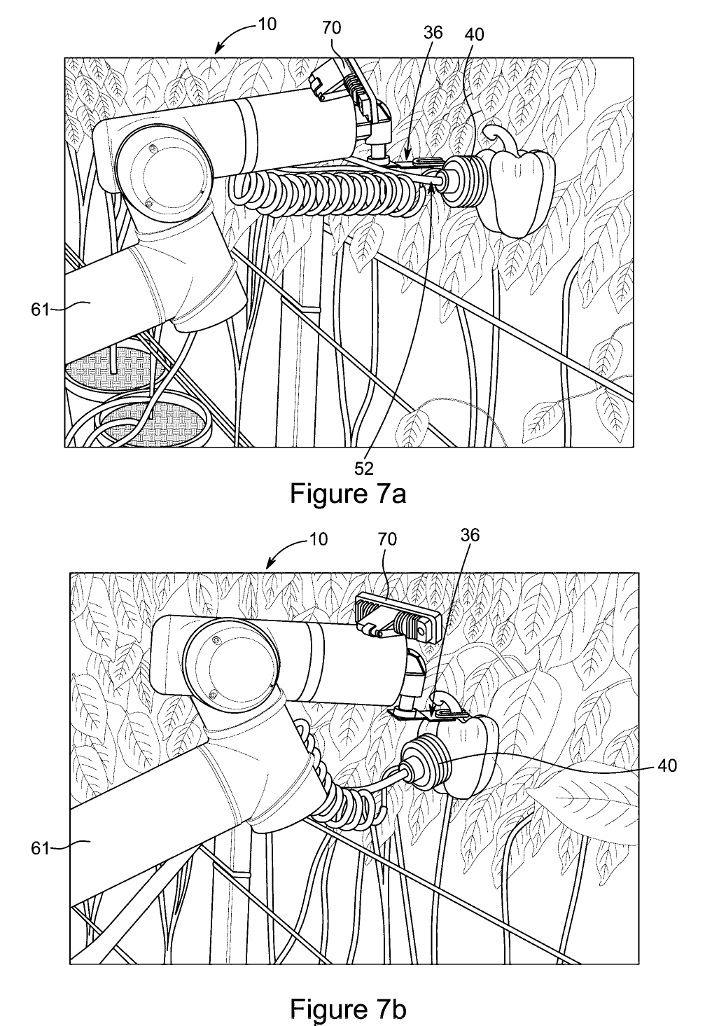

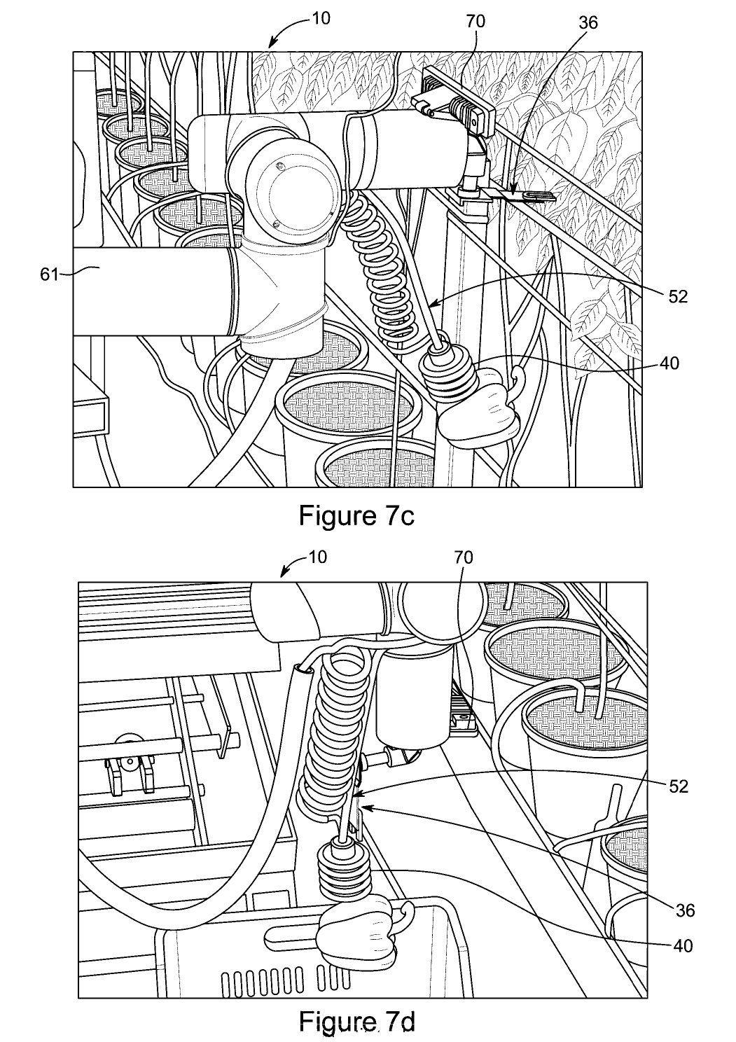

Attach gripper to crop: The arm 110 is moved to allow the suction cup 40 to attach to a surface or face of the crop, as shown in FIG. 7a. The attachment point is chosen by the computer on a flat face of the parametric model fitted in step 3. The flat face of the model is chosen as it likely corresponds with a smooth flat area on the surface of the crop.

Decouple gripper from cutting mechanism: The end effector 10 is moved upwards, as indicated by an arrow 61, which causes the magnet 60 to break free or detach from the underside of the cutting blade 36, thereby decoupling the suction cup 40 from the effector body 20. This condition is shown in FIG. 7(b).

Moving tool end to target the stem: The flexible strip 52 allows the arm 110 to move the cutting blade 36 independently of the suction cup 40 when decoupled from the body 20. The harvester 100 moves the arm 110 to an optimum stem-cutting position for the cutting blade 36. The stem cutting position is a position where the cutting blade 36 is offset a predetermined distance from a stem cutting point. The stem cutting point is identified by the computer as a vertical distance above the centre of the modelled top face of the capsicum. The stem cutting point may also be identified as being vertically above the centroid of the parametric model, as most capsicums tend to hang vertically.

Stem cutting: The cutting blade 36 is moved forward from the stem cutting position to cut the crop stem free from the plant, as shown in FIG. 7(c). After the stem is cut, the crop remains attached to the end effector body 20 via the flexible strip 52. The crop falls away from the plant from which it has been cut and is only attached via the strip 52.

Magnet recoupling: The robot arm 110 is moved so that the end effector 10 points downwardly over a collection crate. This passively re-aligns the suction cup 40 with the cutting blade 36 under the force of gravity where it magnetically re-attaches to the cutting blade 36 in its original position ready to harvest another crop

Release crop: The vacuum is released from the suction cup 40 when the robotic arm 110 is in a drop-off position, as shown in FIG. 7(d), causing the crop to drop into the collection crate. The robotic arm 110 can move the crop to a suitable drop-off position after the suction cup 40 is re-attached and before the vacuum is released. The crop can also be released before the suction cup 40 is magnetically re-attached. In the embodiment where the strip 52 is resiliently deformable, the strip 52 returns to its original shape after the crop is released. Using a strip 52 which is resiliently deformable may obviate the need to point the effector 10 downwardly for re-coupling. The resilience of the strip 52 will return the suction cup 40 to a position for the magnet 60 to magnetically reattach to the cutting blade 36. The resilient deformability of the strip 52 can provide sufficient rigidity so that the magnet 60 is not required to secure the suction cup 40 relative to the effector body 20, but allows enough flexibility to decouple the suction cup 40 relative to the effector body 20.

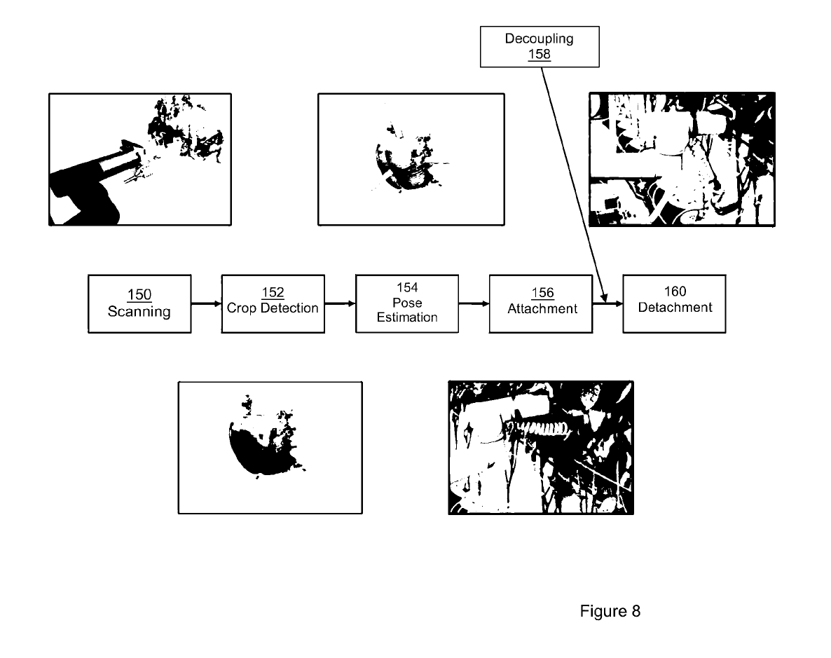

The steps described above are part of five stages of the harvesting operation. FIG. 8 shows the five stages, which include scanning 150, crop detection 152, pose estimation 154, attachment 156 and detachment 160. The suction cup 40 is decoupled with respect to the cutting blade 36 as indicated by step 158 between the attachment 156 and detachment 160 stages.

The different stages and the decoupling step are described in more detail below.

### Scanning

In the first stage, a scanning motion is used to build up a 3D scene of the world using the RGB-D camera 72. The camera 72 is part of the end effector 10, which is moved to build up the 3D scene in an eye-in-hand configuration. The information from the RGB-D camera 72 is registered using a Kinect Fusion (trademark) (Kinfu) algorithm to produce a high-fidelity 3D scene. The Kinect Fusion is an algorithm that provides 3-D object scanning and model creation for a Windows (trademark) sensor. Further information about the product can be found in the Microsoft (trademark) developer material, for example, at: https://msdn.microsoft.com/en-us/library/dn188670.aspx. 3D model reconstruction algorithms other than Kinect Fusion may be used.

### Crop Detection

The crop, for example the capsicum, is segmented from the 3D scene using a crop detection step based on colour information. Capsicums present a range of challenges for crop detection, including varying crop colour and the presence of high-level occlusion.

The detection system is robust to different viewpoints and varying levels of occlusion. The robotic harvester 100 can detect capsicums in two ways: 1) only using colour information (the naïve colour detection method) and 2) both colour and texture information with a probabilistic framework (the Conditional Random Fields or CRF method).

The naive colour detection method uses just colour information. The method was developed to detect red (ripe) capsicums and was integrated because of its real-time performance and relative accuracy for detecting red capsicums. Detecting red capsicums from a predominantly green background of leaves and stems is relatively easy.

The naïve colour detection method makes use of a trained model based on colour information, (hue, saturation, and value). Statistical information such as mean and standard deviation are computed from training images consisting of red and green capsicum images. Given the hue, saturation, and value (HSV) colour Gaussian distribution, a likelihood is calculated for every pixel in an image. RGB colour space may not be appropriate for capsicum detection application because of its high correlation between its components. The colour space does not consider the brightness of colours and thus assigns different values for different shades/brightness of the same colour. This can result in problems in certain conditions where the light will reflect differently off various surfaces of a solid colour object for example as a result of shadows obscured by the plants themselves. HSV colour space, on the other hand, has a component that considers the brightness of a pixel. Therefore, the colour components of this space are not significantly affected by varying shades of the same colour. This is useful for visual crop detection tasks as objects reflect light differently depending on the angle of incidence onto a surface. Naïve colour detection is a simple and intuitive method and shows sufficient performance in detecting red capsicums.

The CRF method was developed as an extension of the naïve colour detection method to be able to detect not only red capsicums, but also green capsicums. The method makes use of colour, texture, and shape information with multi-spectral images. Detecting green capsicums is important for estimating the current quantity of crop. Also, some farms will pick green capsicums as well, even though it is usually a lower value crop.

The CRF method uses four visual features in a probabilistic framework: HSV, Sparse Auto Encoder (SAE), Histogram of Oriented Gradients (HoG), and Local Binary Pattern (LBP). Each feature captures a different property such as the distribution of local gradient, edges, and texture. SAE feature is an unsupervised feature learning method based on neural networks. This feature mainly encapsulates edge information with learned kernel filters which is insufficient to distinguish a capsicum from cluttered background scene. The HoG feature captures the distribution of local gradient magnitude and orientations. Although HoG has demonstrated outstanding detection performances for a somewhat structured object (e.g., pedestrians, horses, bicycle, and motor bike), it was found to perform relatively poorly at the capsicum detection task where it is highly difficult to distinguish structures of the crops. The last feature is the Local Binary Pattern (LBP) that is a simple and powerful feature descriptor. It has been previously used for several computer vision tasks such as image, video, face and texture classification tasks. LBP was found to be efficient at computing and capturing the smooth surface of a capsicum.

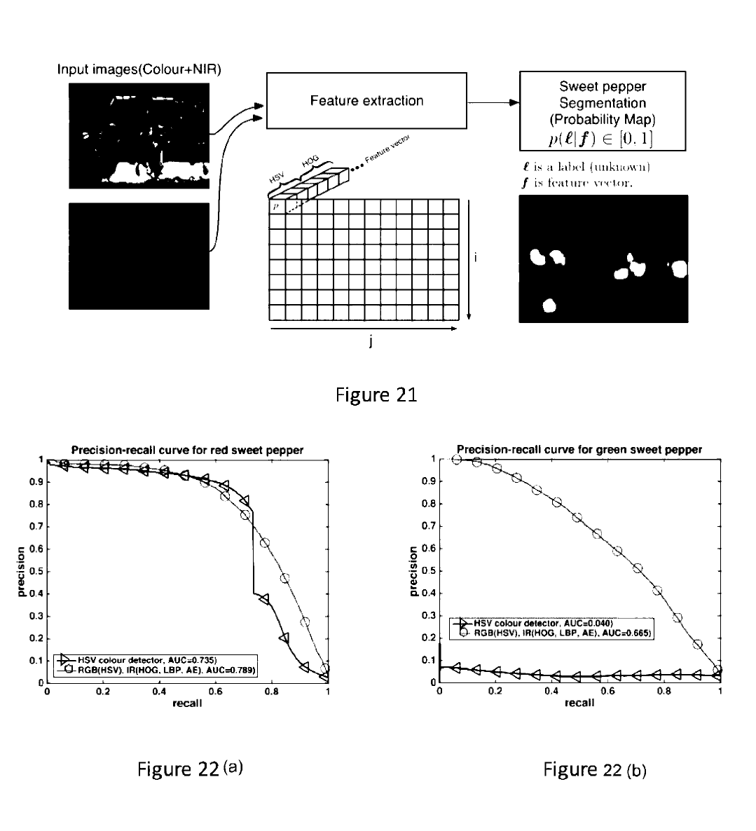

Sweet pepper segmentation refers to the process through which a probability map is obtained. This map declares the probability that a pixel is determined as a sweet pepper. Pixels with a higher probability of belonging to a capsicum are indicated by white pixels and those with a low probability are indicated by black pixels. For example, in FIG. 21 there is shown instances of green and red capsicum detection using a CRF-based detector method. FIG. 21 shows a capsicum detection pipeline. First, the images are required and extracted using a multi-spectral function of the camera 72, namely colour and near-infrared. Second, a pixel -wise segmentation is performed to state the probability that a pixel is identified as a capsicum. The higher in intensity of the relevant pixel, the higher the probability that it is identified with a capsicum.

The CRF-based detector method was found to outperform the naïve colour detector method in red and green capsicum detection.

It is envisaged that other detection methods could be applicable as a result of technological advances in this field.

### Pose Estimation

Segmented 3D information about a target capsicum is isolated to estimate the pose or orientation of the crop. The pose is estimated by fitting a parametric model to the data via online non-linear optimisation. The optimisation returns the parameters of the model which describe the shape, size and pose of the capsicum in the world.

The pose of a capsicum is estimated by fitting a geometric model to the captured surface. A constrained non-linear least squares optimisation is used to find the parameters to fit a superellipsoid, which is a subtype of a superquadric model. A superellipsoid can describe a range of different primitive shapes. One of the most useful features for capsicums is the ability to fit flat surfaces with curved edges to produce a curved cube or rectangular prism model. It is this property that is used to estimate the pose of the crop. The assumption is made that the cultivar of capsicum chosen to be harvested are of a block nature, which are desirable at market.

The implicit equation of a superellipsoid is given as:

$$f ( x , y , z ) = {[ {( \frac{x}{a} )}^{\frac{2}{{ɛ}_{2}}} + {( \frac{y}{b} )}^{\frac{2}{{ɛ}_{2}}} ]}^{\frac{{ɛ}_{2}}{{ɛ}_{1}}} + {( \frac{z}{c} )}^{\frac{2}{{ɛ}_{1}}} = 1$$

where a, b and c determine the scale of the model in x, y and z respectively.

The curvature of the model is determined by the two parameters ε₁ and ε₂. Six additional parameters Tx, Ty, Tz, ø, θ and ψ are also used within the optimisation and define the transform _{w}^{c}T between the unit axis of the geometric model and the data.

A pre-processing step is applied to a point cloud which aligns the points along the first principal component and translates the points to the centroid. The transform is preserved during this pre-processing step and is re-applied to the points after fitting the data.

Following the pre-processing step, the transformed points are passed into a nonlinear least squares optimiser. The cost function for the least squares optimisation is below.

$${min}_{k} {\sum }_{k = 0}^{n} {( \sqrt{abc} ( {f ( x , y , z ; α )}^{{ɛ}_{1}} - 1 ) )}^{2}$$

where α represents the eleven parameters of the optimisation problem and their range is given in the table below.

| | a, b, c | Tₓ, T_{y}, T_{z} | θ, ϕ, ψ | ϵ₁, ϵ₂ |
|---|---|---|---|---|
| min. | 0 | 0 | −0.375π | 0.1 |
| max. | 0.1 | 0.02 | 0.375π | 0.7 |

The \sqrt{abc} term in the cost function is used to penalize large volumes.

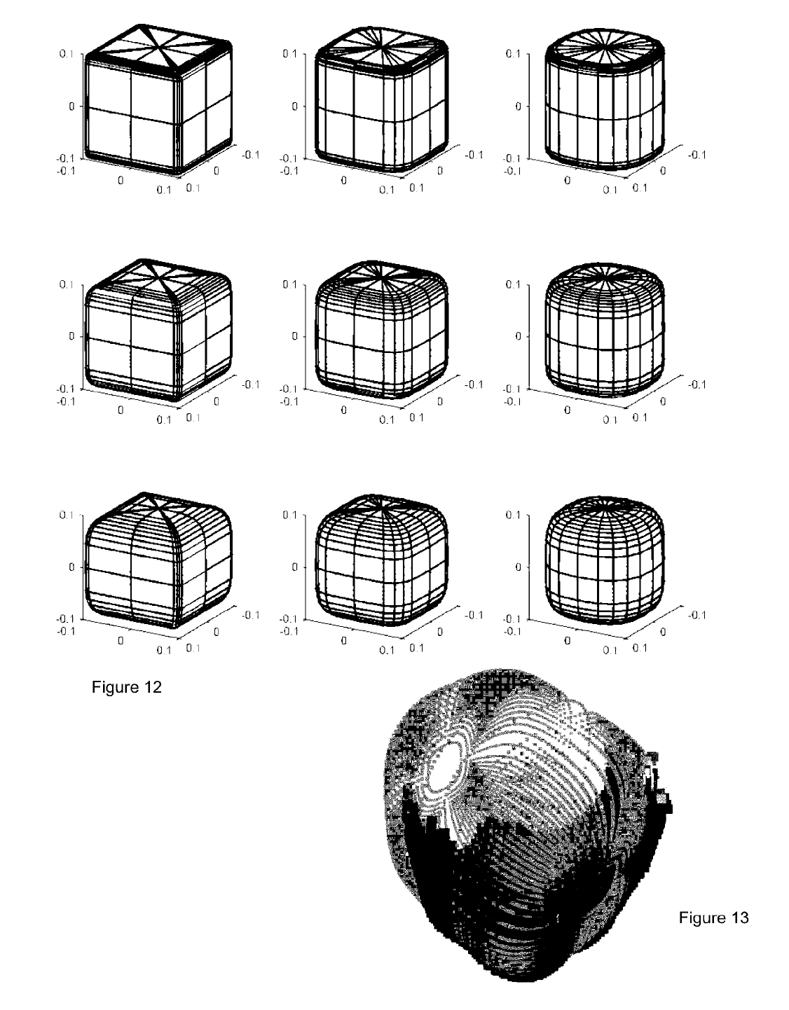

The range of superellipsoids which are used to fit to capsicums are shown in FIG. 12.

FIG. 13 shows a superellipsoid fitted to a capsicum.

The last step in this approach is to estimate the grasp pose using the pose of the capsicum. The rotation of the grasp is first determined in world coordinates defined as _{W}^{G}R. Estimating the grasp rotation can be difficult as the solution found by the superellipsoid optimisation results in a coordinate system uvw that is arbitrarily assigned.

The objective is to recover the axes that represent the front, side and top axes of the target crop. The method finds the axes of the superellipsoid coordinate system that align with the desired world coordinate system. For example, the x-axis of the world represents the front of the robot and is the axis the grasp pose is to be aligned with. Similarly, the z-axis of the world represents the vertical orientation of the platform.

To determine the rotation of the grasp pose, the following steps are used. Firstly, we use the sweet peppers rotation matrix _{W}^{C}R, which is defined as

$${}_{W}^{C} R = [ \begin{matrix}{u}_{x} & {v}_{x} & {w}_{x} \\ {u}_{y} & {v}_{y} & {w}_{y} \\ {u}_{z} & {v}_{z} & {w}_{z}\end{matrix} ] = [ \begin{matrix}u & v & w\end{matrix} ]$$

The index of the maximum absolute component is found for the front and top axis corresponding to the first and third row in _{W}^{C}R, and assigns the column vector to the corresponding column vector of the grasp rotation matrix _{W}^{G}R. This approach is described in the following algorithm

Algorithm 1 Grasp Rotation from Crop

| | |
|---|---|
| 1: | for j ∈ {1, 3} do |

| | |
|---|---|
| 2: | i = arg max (\|uⱼ\| , \|vⱼ\| , \|wⱼ\|) |
| 3: | _{W}^{G}R*_{,j} = _{W}^{C}R_{i,}* |

| | |
|---|---|
| 4: | end for |
| 5: | _{W}^{G}R*_{,2} = _{W}^{G}R*_{,1} × _{W}^{G}R*_{,3} |

where j represents the jth row. To ensure the new coordinate system of the grasp pose is a right-hand-system, the last step is to compute the column vector _{W}^{G}R*₂ defining the side axis of the crop pose to be the cross product of its front and top axes.

### Attachment

The attachment stage uses the estimated pose of the capsicum to plan the motion of the robot arm 110 for attachment to the crop. The suction cup 40 is aligned with a selected face of the capsicum using the pose and shape information.

The attachment stage includes moving the arm 110 so that the suction cup 40 can suction grip or latch onto the capsicum. The suction cup 40 grips onto the capsicum due to the partial vacuum created in the suction cup 40 by the vacuum pump 140. During the gripping operation, the suction cup 40 is magnetically attached to the cutting blade 36, allowing the robot arm 110 to control the position of the suction cup 40 to grip the capsicum (see FIG. 7(a)).

### Decoupling

After the suction cup 40 is attached, the robotic arm 110 moves the cutting tool 30 to a position to cut the capsicum stem in the detachment stage. The suction cup 40 is decoupled by moving the cutting tool 30 from the position or pose to attach the suction cup to the position or pose for cutting the stem of the capsicum. The weight of the capsicum and the rigidity of the plant is sufficient to break the magnetic coupling force between the magnet 60 and the blade 36 when moving the cutting tool 30 away from the attachment position to the detachment position. The suction cup 40 remains connected to the robot arm 110 via the strip 52 (see FIG. 7(b)).

Decoupling allows independent motion of the robot arm 110 for the attachment step and the detachment step.

### Detachment

Detachment is performed by moving the robotic arm so that the blade 36 cuts through the stem of the capsicum.

### Logic

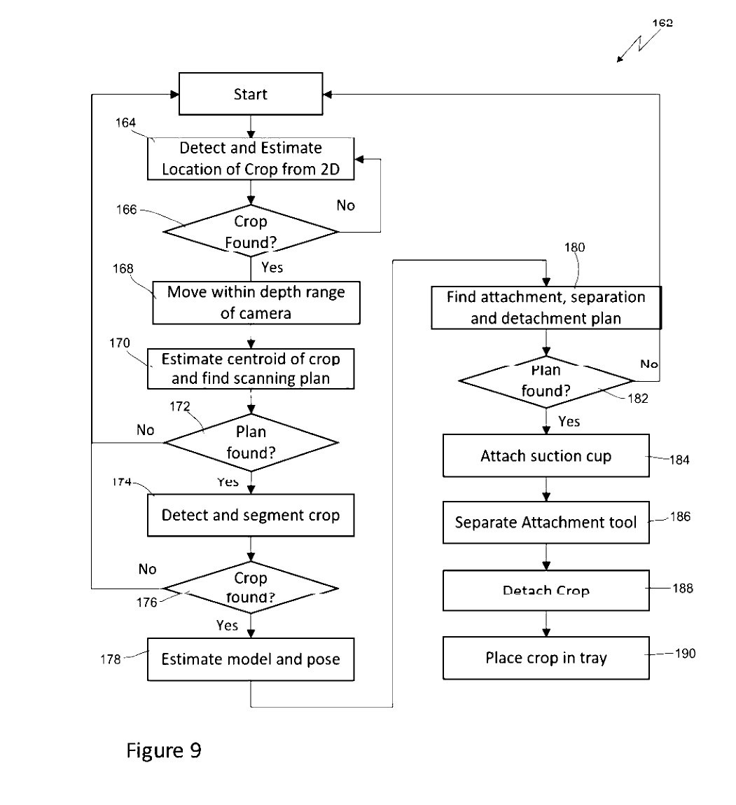

FIG. 9 is a logic flow diagram 162 with decision points between various robotic harvesting steps.

The robotic harvester 100 starts by detecting and estimating the location of a crop using 2D imaging at step 164. If the crop is found, as indicated at decision step 166, then the camera 72 is moved to within depth range for 3D scanning at step 168. The robotic harvester 100 continues with 2D detection as long as no crop is found.

The computer estimates the centroid of the crop at step 170 and proceeds to find a scanning plan. If no scanning plan is found, as indicated at decision step 172, then the robotic harvester 100 returns to the start point to start detecting and estimating the location of the crop again. If a scanning plan is found, then the robotic harvester 100 proceeds to scan the crop to detect and segment the crop as previously described and indicated by step 174.

If no crop is identified at step 174, then the robotic harvester 100 returns to the start point to start detecting and estimating the location of the crop again. If the crop is found as indicated at decision step 176, then a model and pose of the crop is estimated at step 178.

The computer attempts to find an attachment, separation and detachment plan at step 180 based on the model and pose of the crop. If no plan is found, the robotic harvester 100 returns to the start point to again start detecting and estimating the location of the crop. If the plans are found as indicated at decision step 182, then the robotic harvester proceeds to attach the suction cup 40 to the crop as indicated by step 184 and as previously described.

After the suction cup 40 is attached, the suction cup 40 is decoupled as indicated by step 186 and as previously described. The crop is detached as indicated by step 188 and as previously described, before being dropped or placed into a tray at step 190.

### Software

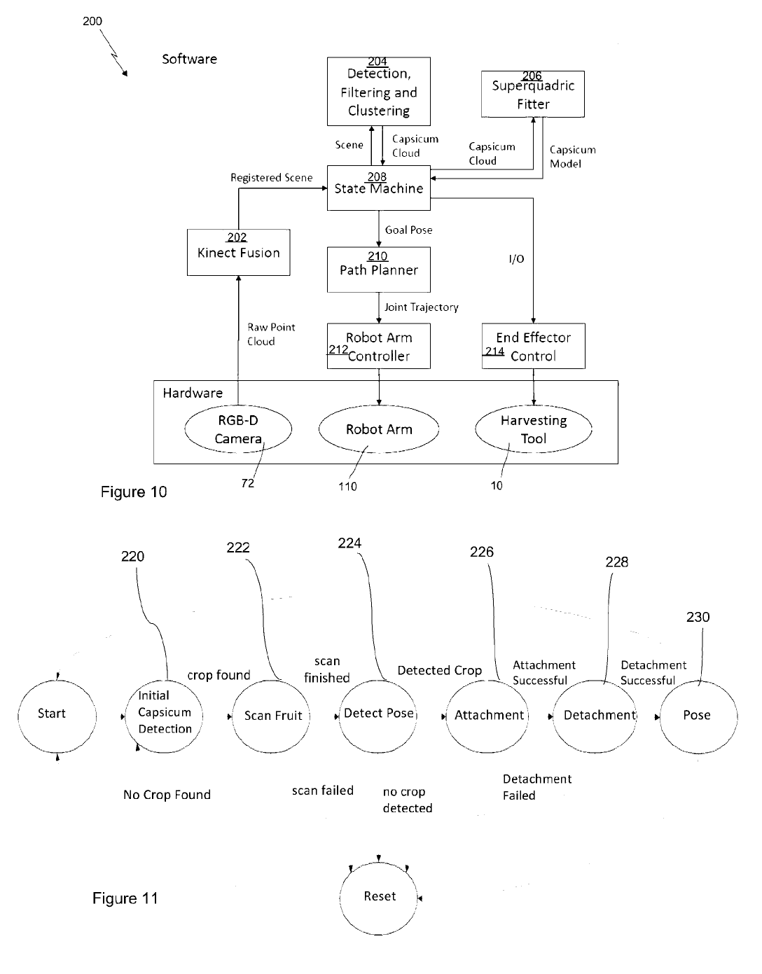

Referring to the block diagram of FIG. 10, different software components or subsystems of a software system 200 of the robotic harvester 100 are shown.

The software system 200 is designed around the Robot Operating System (ROS) framework using nodes for each independent process. The software is broken into five different subsystems, which include the Kinect Fusion subsystem 202, a detection and segmentation subsystem 204, a superquadric fitter subsystem 206, a state machine 208 and a path planner subsystem 210.

FIG. 12 illustrates how each subsystem is connected. The raw information from the RGB-D camera 72 is used within the Kinect Fusion subsystem 202 to reconstruct the 3D scene. The state machine 208 uses the registered scene and the detection and superquadric fitter subsystem 206 is used to estimate the pose of a capsicum. The pose of the capsicum is then used to perform the harvesting actions using a path planner subsystem 210, a robot arm controller 212, and an end effector controller 214.

The different states for the state machine 208 are shown in FIG. 13, which outlines the logic used for a single harvesting cycle for sweet peppers. The state machine 208 is the central node of the software system 200 which interfaces with each other process to perform the harvesting operation.

A first state 220 of the harvesting operation involves an initial capsicum detection step which asks for a segmentation of a 2D image from the camera 72 from a starting pose that has a large field of view of the sweet peppers. A 2D image is used for initial segmentation as the maximum depth of the RGB-D camera 72 is about 0.5 m. A planar assumption is used to estimate the location of the capsicum within the 2D image. The planar assumption is used to move the robotic arm 110 within the depth range of the RGB-D camera 72 to get an improved estimate of the capsicum's location and to start the scanning stage.

If a capsicum is detected within this initial detection state, the system transitions into a scanning state 222. The scanning state first asks for a detection and segmentation of a capsicum using the initial view of the scene from the Kinect Fusion subsystem 202, which only has a front-on estimate of the shape and location of the capsicum. Using this initial segmentation of the capsicum, a centroid of a returned point cloud is used to start a scanning motion to scan the capsicum for multiple views.

The Kinect Fusion subsystem 202 is configured to receive raw point clouds from an RGB-D sensor and to register consecutive frames into a smoothed point cloud for further processing. The system 202 utilises the open-source implementation of the Kinect Fusion algorithm within the Point Cloud Library (PCL).

### Scene Registration

The camera 72 is moved in a trajectory which gives multiple views of the crop, providing enough 3D information about the crop for subsequent stages of the process. As the camera moves, the information is continuously passed to the subsequent stages to estimate the pose of the crop or capsicum. A single scanning trajectory is constructed as a combination of translations and rotations of the camera 70 about the initial estimated location of the capsicum.

A pose detection state 224 consists of combining the point clouds into a coherent point cloud from multiple viewpoints as the robot arm 110 moves through the scanning motion. The Kinect Fusion subsystem 202 receives raw point clouds from the RGB-D camera 72 and registers consecutive frames into a smoothed point cloud for further processing. The system utilises an open-source implementation of the Kinect Fusion algorithm within the Point Cloud Library (PCL). The registration method produces two key outputs: an estimate of the current camera pose and a merged point cloud.

An advantage of using an eye-in-hand camera is that the robot arm joint states provide a high bandwidth update about the camera's pose. However, an accurate rigid calibration between the camera and the end effector of the robot arm is required. Also, accurate time synchronisation is required between the joint states and the camera data.

Different registration methods may be used, for example a standard Iterative Closest Point (ICP) method, a Normal Distribution Transform (NDT) method and a Kinect Fusion (Kinfu) method. The Kinect Fusion is preferred for the robotic harvester 100 as it was found to track the camera pose better than the other techniques. Kinect Fusion provides accurate tracking of the camera pose whilst producing rich scene reconstruction from multiple viewpoints of the camera. The Kinect Fusion package used is from the open-sourced version released as part of the Point Cloud Library (PCL).

After the pose of the capsicum has been successfully detected, attachment 226, detachment 228 and placement 230 states follow in sequence as has been previously described.

### Experiment 1: Detection

A performance evaluation was carried out on two systems incorporating the end effector 10. The performance is presented using an area under a precision-recall curve. Precision (P) and recall (R) are given by:

$$P = \frac{{T}_{p}}{{T}_{p} + {F}_{p}} , R = \frac{{T}_{p}}{{T}_{p} + {F}_{n}} ,$$

where Tₚ is the number of true positives (correct detections), Fₚ is the number of false positives (false alarms), and Fₙ is the number of false negatives (mis-detections). The closer to 1 implies the better detection performance.

For evaluation, we divided the annotated data into training and test sets as shown in the following table:

| | Red sweet pepper | Green sweet pepper |
|---|---|---|
| Train set | 20 (66.7%) | 19 (50%) |
| Test set | 10 (33.3%) | 19 (50%) |
| Sum | 30 (100%) | 38 (100%) |

The training set was utilised to train the models for naïve and CRF-based detection, and the AUC was calculated against a test image set. The same train and test set images are utilised for each detector for the fair comparison.

FIGS. 22(a) and (b) show the final results for red and green sweet pepper detection and their summary is presented in the following table:

| | Red sweet pepper (AUC) | Green sweet pepper (AUC) |
|---|---|---|
| Naïve | 0.735 | 0.040 |
| CRF-based | 0.789 | 0.665 |

Both systems show reasonable performance for red capsicum detection. There is only 0.05 AUC difference. It is noted that there is a significant precision performance drop around 0.7 recall rate for the colour detector. This is an expected result for a deterministic approach, assuming that an HSV colour model (i.e., mean and standard deviation for each HSV channel) was trained using a trained dataset. However, there may exist sweet peppers in a testing dataset that do not belong to the model. These sweet peppers are treated as background and increase Fₚ false positives (false alarms) which results in decreasing the precision. This can happen due to a variety of error sources such as varying light conditions, motion blur, and uneven surface reflection. A technical difficulty is the incorporation of all possible scenarios.

Colour detection of green capsicums with green background can also be difficult as shown in FIG. 22(b).

On the other hand, CRF-based detection demonstrates consistent results for both red and green sweet pepper (0.789 and 0.665 AUC respectively). This probabilistic framework makes use of colour features and texture feature obtained from RGB and NIR (near infrared) images. In addition, it considers not only the likelihood between a pixel and label (unary term) but the neighbouring information (pairwise term) for the inference. Thus, continuous pixel-level segmentation can be generated as opposed to the coarse/sparse result with colour detection.

In addition, using RGB and NIR information with the right visual features (texture) is significant for building a discriminative model.

### Experiment 2: Scene Registration and Pose Estimation

Precise 3D object representation and camera pose tracking are required to accurately estimate an object's pose. Three approaches to perform point cloud registration were examined. There were: Kinfu (Newcombe et al., 2011; Izadi et al., 2011), ICP (Horn et al., 1988; Horn, 1987); and NDT (Rusinkiewicz and Levoy, 2001). To obtain the point cloud data, and pose ground truth, an RGB-D camera was mounted on a robotic arm and moved over a known trajectory (forwards and backwards only). The pose ground truth was obtained from the odometry of the robotic arm, which was accurate up to 0.1 mm.

Both the quantitative and the qualitative analysis showed that the Kinfu algorithm provides consistently better performance than either ICP or NDT. The quantitative results showed that the Kinfu algorithm provides a better estimate of the pose across all the data. Furthermore, the standard deviation of the pose is lower for the Kinfu algorithm compared to ICP and NDT. A qualitative analysis showed that the Kinfu algorithm provides a better reconstruction of the sweet pepper model than the ICP and NDT models. Both ICP and NDT resulted in only partial sweet pepper models. The poor performance of the ICP and NDT approaches are attributed to the fact that they are used in a frame-to-frame manner. By contrast, the Kinfu algorithm is a frame-to-model approach and it is understood that this helps to minimise the accumulation of errors.

A 3D model was fitted to an estimated point cloud that was produced by the Kinfu algorithm. The 3D model was a super ellipsoid which has 5 parameters. The estimation of the pose lead to a total of 11 parameters. To estimate these parameters, a constrained non-linear optimiser (Agarwal et al.) was used. Qualitatively, an adequate fit was yielded.

The effectiveness of the algorithms was examined by attempting to pick sweet peppers in a controlled experiment. In the experiment, a crop was located in front of the camera at an unknown pose and the robotic arm scanned the environment, horizontally and vertically (10 cm for each), to generate a 3D model using the Kinfu algorithm. To grasp the sweet pepper, a suction cup was mounted under the camera and was manually calibrated (the transformation between the camera and the suction cup).

60 trials were conducted with the crop at different poses. It was found that 80% of the sweet peppers could be picked. A naïve experiment that only translates the robotic arm towards the detected crop's centre, without considering the orientation of the sweet pepper was conducted. It was found that the method described herein considerably outperforms the naïve method.

It is envisaged that the superellipsoid models could be replaced with more appropriate parametric sweet pepper models.

### Harvest Results

The harvesting method described above was experimentally validated in a real field environment. A test was conducted on a farm in Queensland, Australia, within a protected cropping system. The test results are provided in the table below.

| | | | Predictive |
|---|---|---|---|
| Success Rate | | Percentage | probabilities |
| Overall detachment | 2 | 92% | 89% |
| Attachment & detachment | 4 | 58% | 59% |
| Unmodified attachment & detachment | 1 | 46% | 46% |
| First attempt attachment & detachment | | 33% | 44% |

The test data is provided in the table below where s=success and f=failure.

| | Modifi- | At- | Plan- | Detec- | Attach- | Detach- |
|---|---|---|---|---|---|---|
| Capsicum | cation | tempts | ning | tion | ment | ment |
| 1 | | 1 | S | S | S | S |
| 2 | | 2 | S | S | S | S |
| 3 | | 1 | S | S | S | S |
| 4 | RL | 4 | S | S | F | S |
| 5 | RL, AC | 4 | S | S | F | S |
| 6 | RL, AC | 4 | F | S | F | F |
| 7 | | 3 | S | S | F | S |
| 8 | RL | 3 | S | S | S | S |
| 9 | | 1 | S | S | F | S |
| 1 | | 2 | S | S | F | S |
| 1 | | 1 | S | S | F | S |
| 1 | | 1 | S | S | S | S |
| 1 | | 1 | S | S | S | S |
| 1 | RL | 1 | S | S | S | S |
| 1 | | 1 | S | S | S | S |
| 1 | | 1 | S | S | S | S |
| 1 | | 2 | S | S | S | S |
| 1 | | 2 | S | S | S | S |
| 1 | | 2 | S | F | F | F |
| 2 | | 2 | F | S | F | S |
| 2 | | 1 | S | S | S | S |
| 2 | RL | 2 | S | S | F | S |
| 2 | | 4 | S | S | S | S |
| 2 | RL | 2 | S | S | S | S |

Modifications abbreviated as RL—Removed Leaves and AC—Adjusted Capsicum

During trial 4 of the test, the harvester was not able to select the correct capsicum based on the location of the camera before the scanning step and therefore after 3 failed attempts a leaf was removed to improve the view of the capsicum. This enabled the robot to perform an appropriate scan. However, a planning failure occurred during this attempt causing a failed attachment but a successful detachment.

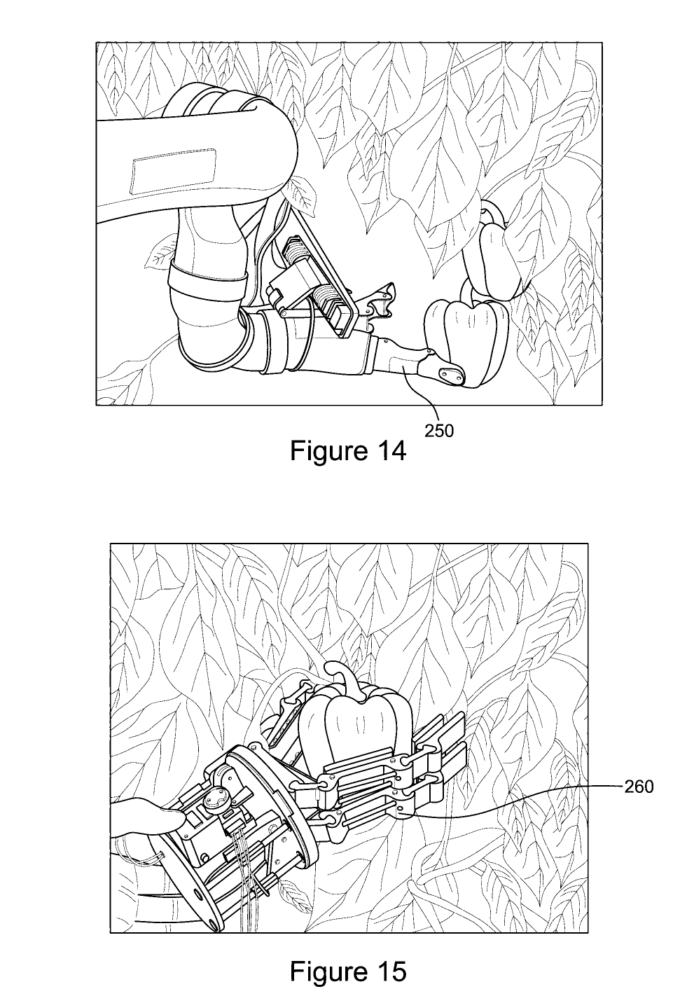

Referring to FIGS. 14 and 15, other types of grippers, which may also be used to attach to the capsicums, are shown. FIG. 14 shows a pinch gripper 250 about to grip onto a capsicum. FIG. 15 shows an under-actuated four finger gripper 260. Many other gripper types may be used to attach to the crop, depending on suitability for the crop type. The suction cup 40 was found to be appropriate for capsicums as it does not grasp neighbouring branches or leaves when latching on to a capsicum.

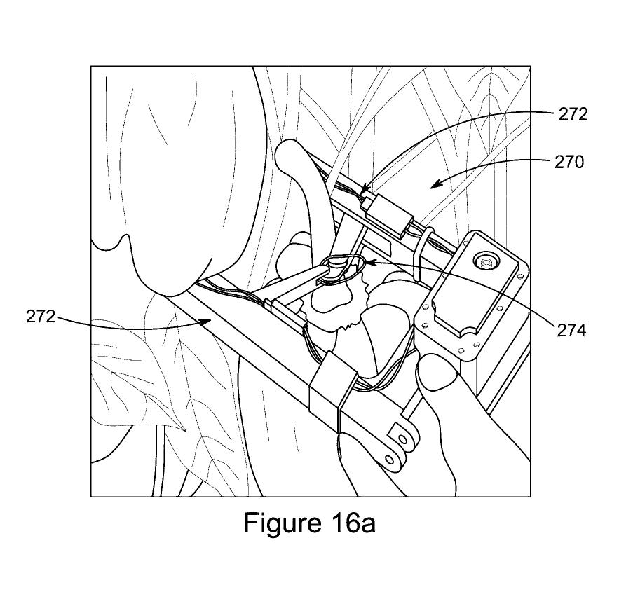

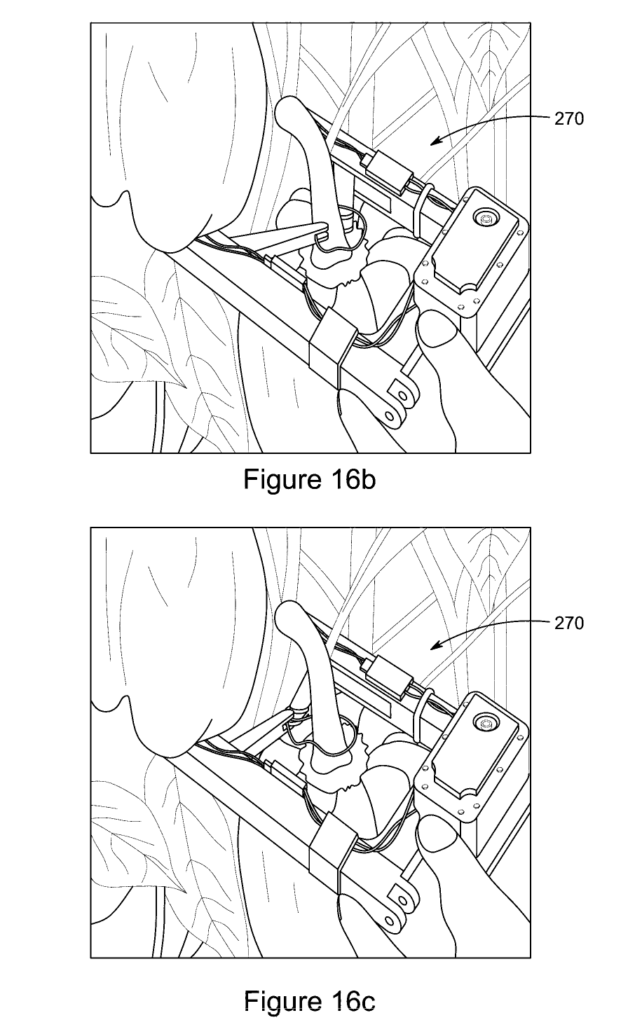

FIGS. 16(a) to 16(c) show steps of harvesting using another embodiment of a cutting mechanism 270 for use with robotic harvester 100. The cutting mechanism 270 uses a thin flexible wire 274 which is wrapped around a peduncle and pulled to slice through it. The cutting mechanism 270 uses fingers 272 which open around the peduncle, pulling the wire around it. The fingers 272 only open in one direction and when closed around the peduncle cause a constraint for the wire 274. The wire 274 is then pulled through the finger mechanism constricting the wire around the peduncle and eventually slicing through it. Micro switches are integrated into the fingers which gives feedback on when the fingers have opened and latched onto a peduncle.

An advantage of the wire cutting mechanism 270 is it can handle uncertainty of the perception system in the estimated location of the peduncle. Another advantage is that it doesn't damage the fruit as the parts of the mechanism for cutting only work for peduncle sized objects. A disadvantage of the wire cutting mechanism 270 is the need to have mechanical parts protrude past the peduncle to latch onto it, which in some cases is not possible due to the shape of the peduncle or the surrounding plant.

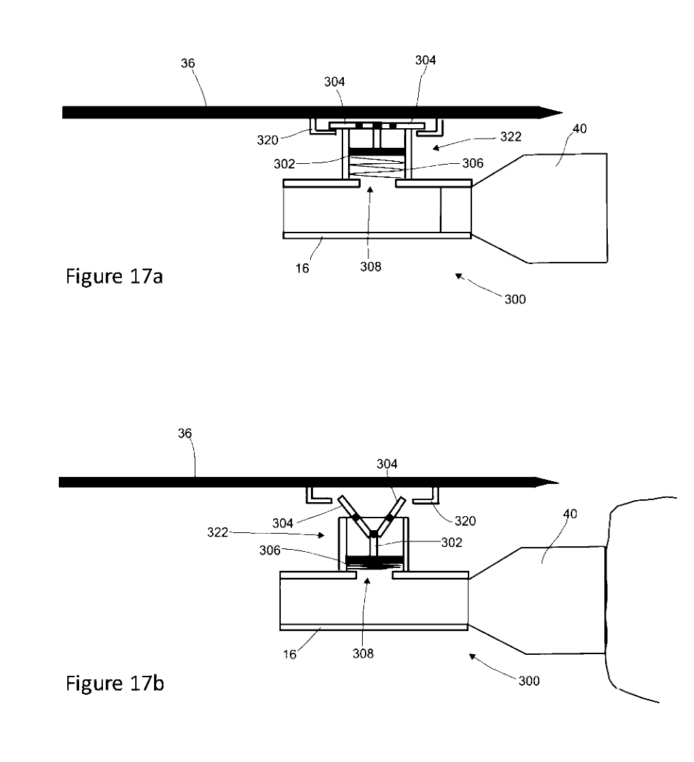

FIGS. 17(a) and (b) show another embodiment of a releasable securing mechanism 300 for coupling the suction cup 40 to the cutting blade 36. The releasable securing mechanism 300 includes a socket 320 and a catch mechanism 322.

The socket 320 is fixed to the underside of the blade 36. The catch mechanism 322 is fixed to the hose coupling 16.

The catch mechanism 322 includes pivotal arms 304 which are connected to a shank of a plunger 302. The plunger 302 is biased to an extended position by a compression spring 306 as shown in FIG. 19. The arms 304 are parallel in the extended position of the plunger 302, thereby to be captured in the socket 320.

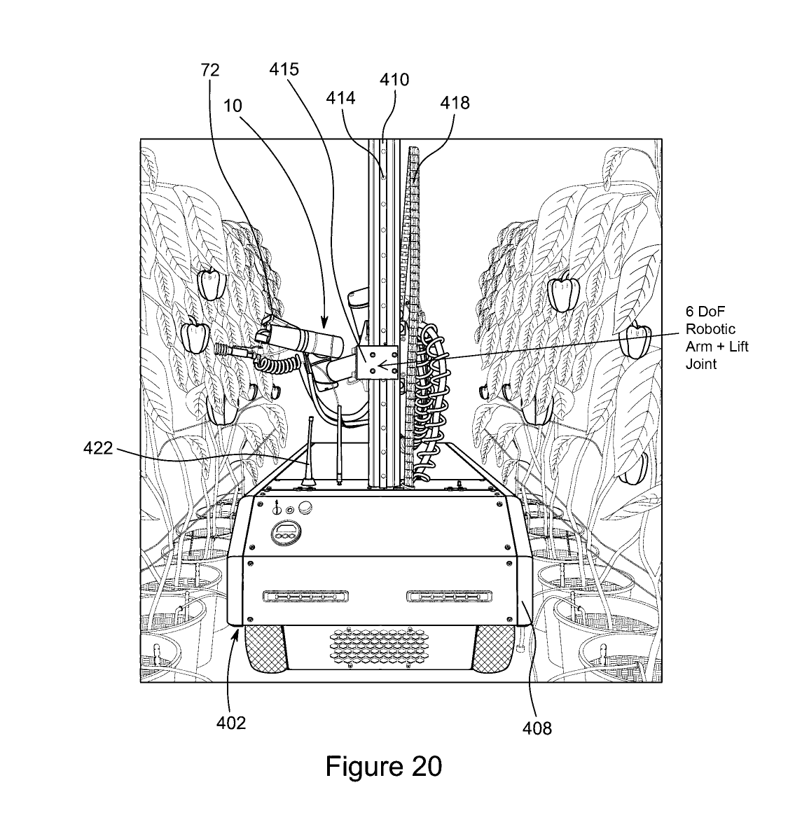

The hose coupling 16 has an opening 308 which opens into a barrel in which the plunger 302 is seated. The opening 308 allows negative pressure in the hose coupling 16 to suck the plunger 302 down into a retracted position when the suction gripper 40 latches onto a capsicum as shown in FIG. 20.

The arms 304 pivot into a V-shape arrangement when the plunger 302 is in the retracted position, thereby releasing the arms 304 from the socket 320.

Releasing the catch mechanism 322 from the socket 320 decouples the suction cup 40 from the cutting blade 36. The suction cup 40 is thus decoupled as soon as it latches onto a capsicum, leaving the robotic arm 110 free to move the cutting tool 30 to go cut the stem.

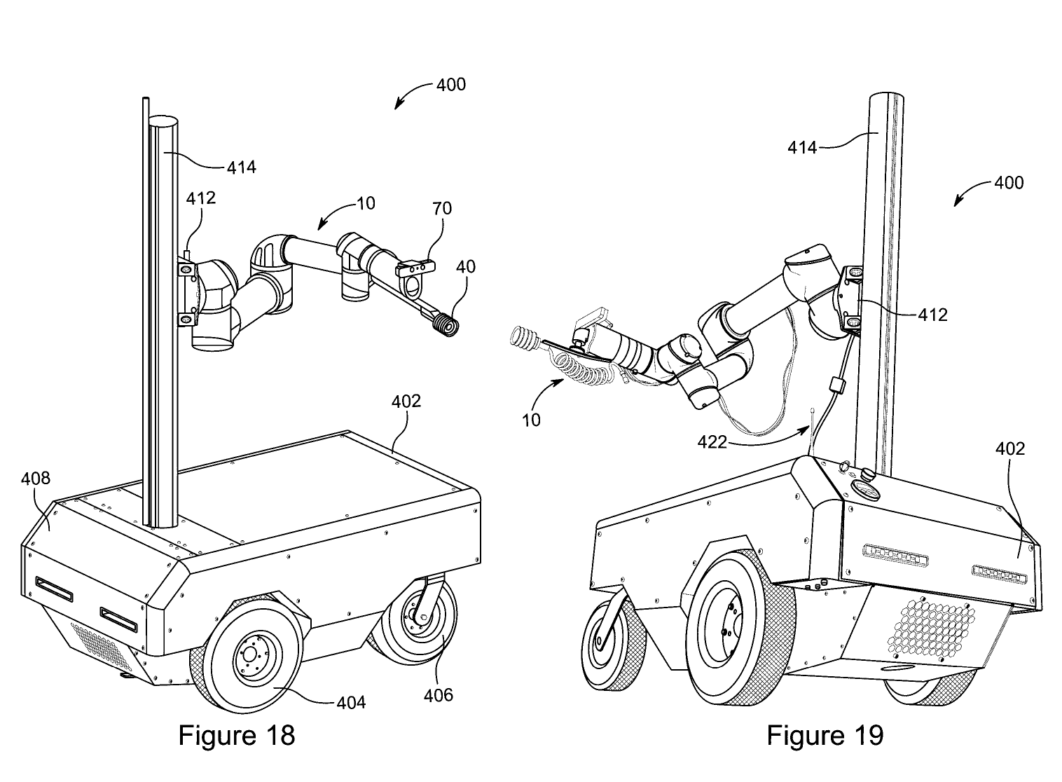

In FIGS. 18 to 20, reference numeral 400 generally indicates a robotic harvester.

The robotic harvester includes a self-driving platform 402. The platform 402 has driven wheels 404 and steering wheels 406. The driven wheels 404 can be driven by a suitable motor and gearbox combination (not shown) or some other rotary actuator positioned in a housing 408 of the harvester 400.

The platform 402 can be remotely steered and driven in a conventional manner. Alternatively, the platform 402 can be automatically steered and driven using any number of conventional mechanisms, such as GPS control, Laser guidance or wireless control via a wireless network that allows the platform to communication with a control station. Instead, the platform 402 can be pre-programmed to follow a predetermined route. In one embodiment, movement of the platform 402 can be governed along with movement of the effector 10 to provide a DOF of movement further to enhance positioning of the effector 10 and, more specifically, the gripper of the effector 10. Thus, the motor and gearbox or rotary actuator can be operatively connected to the computer that is described above with reference to operation of the effector 10. In this example, the computer could be mounted in the housing 408. Alternatively, the computer could be remotely positioned and wirelessly connected to a controller arranged in the housing 408.

A vertical track assembly 410 is mounted on the platform 402. The vertical track assembly 410 includes a linear actuator 412 mounted on a vertical rail or guide post 414. A lift joint 415 is mounted on the actuator 412. One end of the robotic arm 110 is mounted on the lift joint 415 so that the effector 10 can be moved up and down. The actuator 412 can incorporate any suitable drive mechanism, such as a stepper motor, that can be incrementally controlled. The actuator 412 can thus be connected to the computer so that the actuator 412 can be controlled to provide a DOF of movement of the gripper.

In one example, shown in FIG. 23, The actuator 412 can include a chain or belt 418 extending about a sprocket or pulley 420 at an upper end of the post 414 and a driven sprocket or pulley (not shown) within the housing 408. In this example, antennae 422 can be seen for remote or wireless communication with the harvester 400.

The appended claims are to be considered as incorporated into the above description.

In the above description, like reference numerals refer to like parts, unless otherwise specified. The use of common reference numerals is not to be regarded as an indication that any components of one embodiment are essential for another embodiment and is for convenience only.

Throughout the specification, including the claims, where the context permits, the term “comprising” and variants thereof such as “comprise” or “comprises” are to be interpreted as including the stated integer or integers without necessarily excluding any other integers.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

When any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

Words indicating direction or orientation, such as “front”, “rear”, “back”, etc, are used for convenience. The inventor(s) envisages that various embodiments can be used in a non-operative configuration, such as when presented for sale. Thus, such words are to be regarded as illustrative in nature, and not as restrictive.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A crop picking end effector for robotic harvesting of crops, the end effector including:
a body;
a cutting mechanism arranged on the body and operable to cut a stem or stalk of the crop;
a gripper operable to attach itself to the crop; and
a decoupling mechanism including
a tether connected to the gripper and tethering the gripper with respect to the body; and
a releasable securing mechanism which releasably secures the gripper with respect to the cutting mechanism, the releasable securing mechanism configured to allow the gripper to decouple, thereby to release the gripper with respect to the cutting mechanism.

2. The end effector as claimed in claim 1, in which the releasable securing mechanism is a magnet interposed between the cutting mechanism and the gripper.

3. The end effector as claimed in claim 1, in which the gripper is a suction cup.

4. The end effector as claimed in claim 1, in which the tether is a flexible strip that is attached, at one end, to the body and, at another end, to the gripper.

5. The end effector as claimed in claim 1, further comprising a vision system used to detect the crop.

6. The end effector as claimed in claim 1, in which the cutting mechanism is an oscillating power tool including a cutting blade.

7. The end effector as claimed in claim 6, further comprising a guard positioned along the cutting blade.

8. The end effector as claimed in claim 1, in which the tether is resiliently deformable to return to an initial shape.

9. A robotic harvester including a robotic arm and the crop picking end effector as claimed in claim 1 mounted to a tool end of the robotic arm.

10. The robotic harvester as claimed in claim 9, further comprising a vision system which is mounted to the robotic arm.

11. The robotic harvester as claimed in claim 10, further comprising a vacuum pump which is in fluid communication with the gripper.

12. A method of harvesting crops with a robotic harvester, the method including the steps of:
attaching a gripper to the crop using a robotic arm;
decoupling the gripper from the robotic arm so that the robotic arm is operable to move while the gripper remains attached to the crop;
moving the robotic arm to a position where a cutting mechanism of the robotic harvester can target a stem or stalk of the crop; and
cutting the stem or stalk with the cutting mechanism while the gripper is decoupled and attached to the crop.

13. The method as claimed in claim 12, including moving the robotic arm so that the gripper recouples with the robotic arm.

14. The method as claimed in claim 13, including releasing the crop from the gripper.

15. The method as claimed in claim 13, including moving the gripper to a drop-off position after the gripper has recoupled with the robotic arm and before releasing the crop from the gripper.

16. The method as claimed in claim 13, including releasing the crop from the gripper before the gripper has recoupled with the robotic arm.

17. The method as claimed in claim 12, wherein the gripper is attached to the crop using suction.

18. The method as claimed in claim 12, wherein the gripper is decoupled from the robotic arm by breaking a magnetic connection when moving the robotic arm while the gripper remains attached to the crop.
